(19) United States
(12) Patent Application Publication
(10) Pub. No.: US 2011/0047841 A1
(43) Pub. Date: Mar. 3, 2011

(54) PORTABLE SURFACE-MOUNTED LIGHT AND DISPLAY APPARATUS

(76) Inventors: Keith A. SENKYR, Elkton, KY (US); Stewart B. LEWIS, Dunwoody, GA (US)

(21) Appl. No.: 12/549,694

(22) Filed: Aug. 28, 2009

(51) Int. Cl. G09F 13/04; F21V 1/00

(52) U.S. Cl. 40/575; 362/235; 40/541

(57) ABSTRACT

A light fixture includes a base having at least one light source positioned therein, a lens removably mounted over the light source, and a display applied onto the lens for illumination by the light source. In example forms, the display takes the form of a cartoon character, a team logo, product merchandising text and/or graphics, branding materials, informational text or diagrams, patterns, artwork, or the like. Multiple lenses can be provided, each having a different display applied thereon, for interchangeable attachment to a common universal base.

### CROSS-REFERENCE TO RELATED APPLICATION

This application claims the benefit of U.S. Provisional Patent Application Ser. No. 60/093,082, filed Aug. 29, 2008, the entirety of which is hereby incorporated herein by reference for all purposes.

### TECHNICAL FIELD

The present invention relates generally to the field of lighting and decorative displays, and more particularly to a wall or ceiling mountable fluorescent light fixture having a customizable and/or interchangeable diffuser or lens display.

### BACKGROUND

Various forms of lighting fixtures and decorative displays are known. For example, lamps, wall sconces and pendant mounted ceiling lights, lighted signs, and various other devices have been provided. Continued improvement in the field and new product alternatives are sought.

### SUMMARY

In example embodiments, the present invention relates to a fluorescent light fixture that is easily and portably mountable on a wall, ceiling or other surface. The fixture includes a customizable and/or interchangeable diffuser or lens defining a display surface. Various graphical or other display features can be applied economically thereon, for example, popular cartoon characters, team logos, product merchandising text and/or graphics, and the like.

In one aspect, the present invention relates to a lighted display apparatus. The apparatus includes a base having a back panel, a peripheral collar extending from the back panel, and a front that is at least partially open, the back panel comprising one or more mounting features for attachment to a support. The apparatus also includes at least one light source mounted within the base for projecting light toward the at least partially open front of the base. The apparatus also includes a plurality of mounting brackets, each mounting bracket having a first attachment portion, a second attachment portion, and a flexible arm between the first and second attachment portions. The apparatus also includes a lens having a substantially planar panel with a display applied thereon, at least a portion of which is light-transmissive, the lens being detachably affixed to the base by the plurality of mounting brackets, the first attachment portion of each mounting bracket being attached to the base and the second attachment portion of each mounting bracket being releasably attached to the lens, whereby flexure of the flexible arm portion of the mounting brackets allows attachment and removal of the lens.

In another aspect, the invention relates to a light fixture including a base having at least one light source positioned therein, a lens removably mounted over the at least one light source, and a display applied onto the lens for illumination by the light source.

In another aspect, the invention relates to a display method including the steps of attaching a base to a support, the base having at least one light source mounted therein, and having a plurality of mounting brackets attached thereto; and releasably attaching a first lens to the base, the lens comprising a panel having a first display applied thereon, at least a portion of which is light-transmissive.

These and other aspects, features and advantages of the invention will be understood with reference to the drawing figures and detailed description herein, and will be realized by means of the various elements and combinations particularly pointed out in the appended claims. It is to be understood that both the foregoing general description and the following brief description of the drawings and detailed description of the invention are exemplary and explanatory of preferred embodiments of the invention, and are not restrictive of the invention, as claimed.

### BRIEF DESCRIPTION OF THE DRAWINGS

FIG. 1 shows a top perspective view of a light and display apparatus according to an example form of the invention.

FIG. 2 shows a bottom perspective view of the light and display apparatus of FIG. 1.

FIG. 3 shows an exploded or assembly view of the light and display apparatus of FIG. 1.

FIG. 4 shows a side elevational view of the light and display apparatus of FIG. 1 with portions omitted for clarity.

FIG. 5 shows a bottom plan view of the light and display apparatus of FIG. 1 with portions omitted for clarity.

FIG. 6 shows a perspective view of a base portion of the light and display apparatus of FIG. 1.

FIG. 7 shows a top plan view of the base portion of FIG. 6.

FIG. 8 shows a perspective view of a diffuser or lens of the light and display apparatus of FIG. 1.

FIG. 9 shows a perspective view of a mounting bracket of the light and display apparatus of FIG. 1.

### DETAILED DESCRIPTION OF EXAMPLE EMBODIMENTS

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Any and all patents and other publications identified in this specification are incorporated by reference as though fully set forth herein.

Also, as used in the specification including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment.

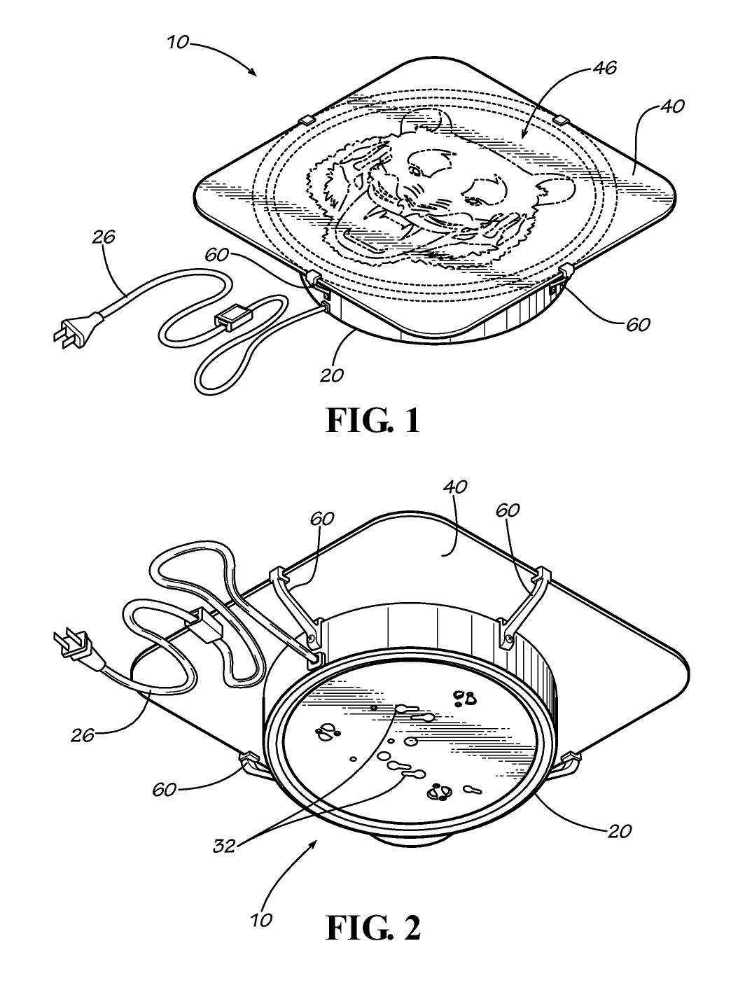

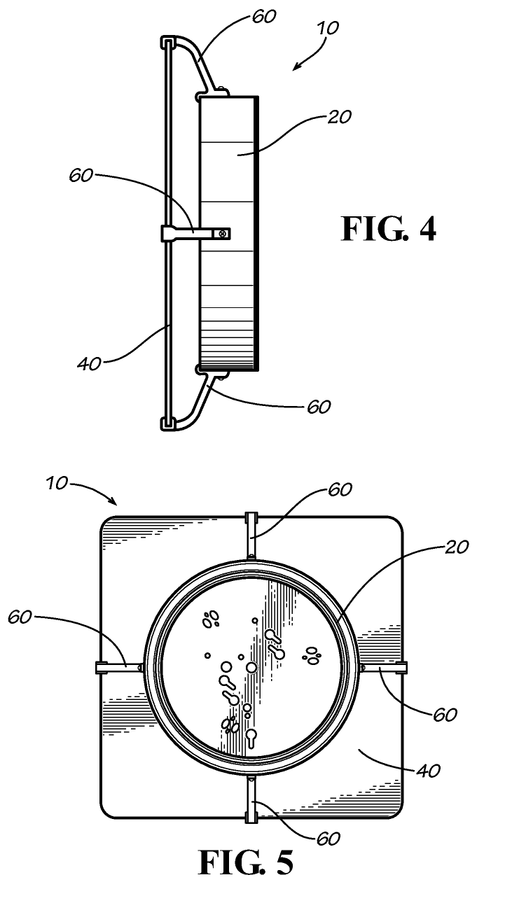

With reference now to the drawing figures, wherein like reference numbers represent corresponding parts throughout the several views, FIGS. 1-2 show a light and display fixture apparatus 10 according to an example form of the invention. The fixture 10 generally comprises a chassis pan or base 20, a diffuser or lens 40, and one or more (four are shown) mounting brackets 60 for securing the diffuser 40 to the base 20. In certain example forms, the overall fixture 10 preferably has a low-profile depth of about 2-3″, for example about 2¾″. FIGS. 4-5 show a side and rear views, respectively, of the apparatus 10, with parts of the apparatus omitted for clarity.

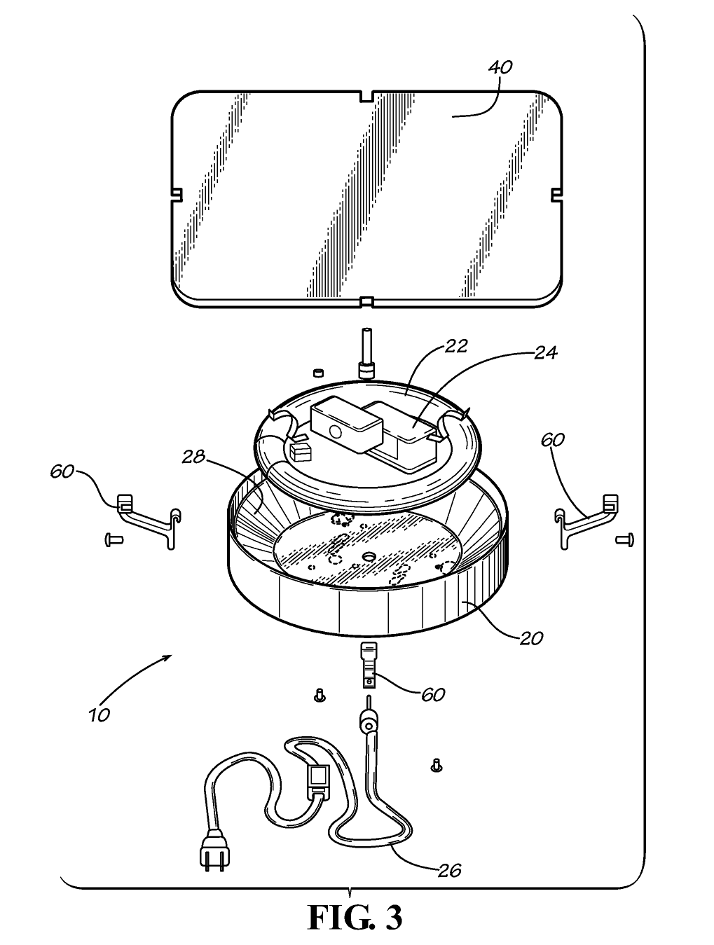

The fixture 10 further comprises one or more light sources 22 mounted on or in the base 20, such as an incandescent or compact fluorescent lamp, fluorescent lighting tube, self ballasted fluorescent bulb, or the like. As shown in FIG. 3, a circular fluorescent light tube 22, such as a 22-watt, 32-watt or 40-watt Circline lamp, is shown in the embodiment. In an alternate form, a pair of D-lamp fluorescent light tubes, arrayed to form a circular periphery, can be provided. Optionally, an electronic ballast 24 and/or driver may be mounted in or on the base 20. In further embodiments, a self-ballasted GU24 fluorescent bulb is utilized as the light source. Any control circuitry or other electronic components and lamp retainers and/or couplings for mounting and delivering power to the light sources can be mounted in or on the base 20 as well. A power cord 26 is provided for connection to an external power source, for example by a two-prong, three-prong or other type of plug for connection to a standard outlet, or alternatively by hard-wired connection. A switch for turning the light on and off is optionally provided, for example in the form of a roll-switch on the power cord. Alternatively, an onboard or remote battery can be provided as a power source.

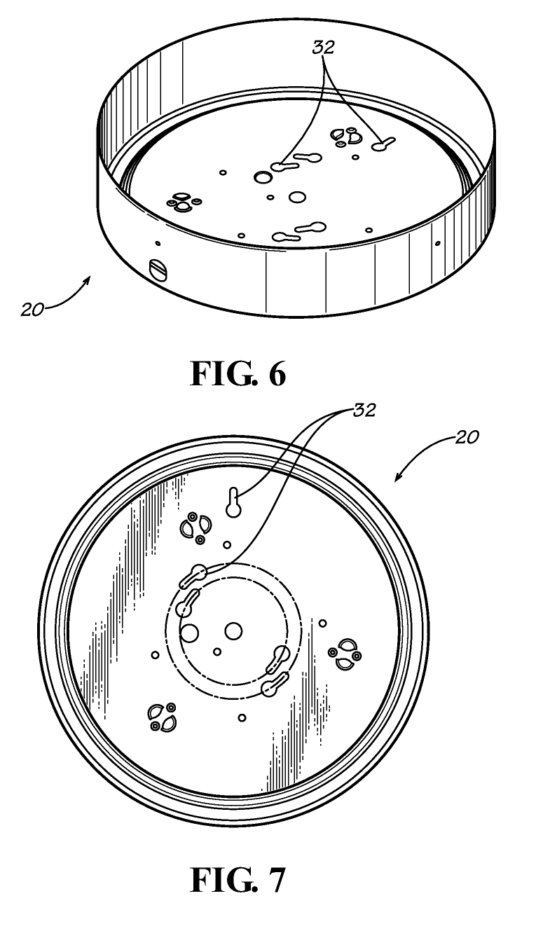

The base 20 is shown in greater detail in FIGS. 6-7, and in the depicted embodiment includes a cylindrical or disk shaped housing having a back panel, a circular rim or collar projecting from its periphery, and a front that is at least partially open. One or more mounting holes 32, or alternate mounting means such as one or more clips, hangers, rings or the like. For example, one or more key-slot and hole mounts can be provided on the back panel of the base, for receiving and retaining the head of a mounting screw or nail. In this manner, the fixture 10 can be semi-permanently, but readily removably mounted to a wall, ceiling or other surface, and the cord plugged into a nearby outlet, or optionally hardwired to an electrical circuit. Optionally, one or more knock-outs are provided in the base 20 for alternate wiring access. The base 20 can be manufactured from materials such as, but not limited to, steel, aluminum, base metal, ceramic, stainless steel, iron, copper, polycarbonate plastic, other plastics, etc. The manufacturing process by which the base 20 may be formed can include, but is not limited to, metal stamping or injection molding, depending on the material used and other factors, such as aesthetic appearance or desired surface finish.

The apparatus 10 optionally includes a reflector 28, as shown in the assembly view of FIG. 3, positioned within the base 20 in order to reflect light from the light source 22 outwards from the base 20. The reflector 28 can be made of any highly reflective and/or heat resistant material, such as, but not limited to, sheet metals, reflective fabrics, reflective films, glass, plastic, etc. Optionally, in the case that the reflector 28 is made from a reflective film or tape, the inner surface of the base 20 can be layered or coated with such a material. In another case, the shape of the reflector 28 can be any appropriate shape for reflecting light out of the base 20, including, but not limited to, a pan shape, a concave shape, parabolic, or a molded geometric shape for maximizing or controlling diffuse or focused reflection depending on the desired application. The reflector 28 can take a variety of forms comprising different materials, shapes, and sizes within the scope of the invention.

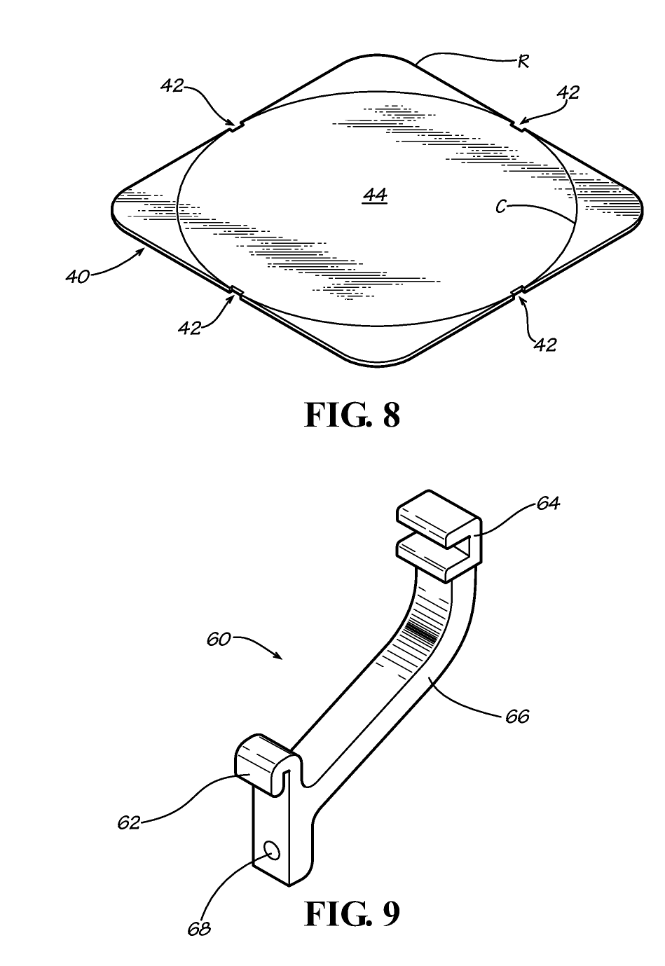

FIG. 8 shows an example version of a diffuser or lens 40 in greater detail. The depicted diffuser embodiment comprises a generally rectangular or square planar panel optionally having rounded corners, indicated by outer periphery R. An alternative diffuser embodiment comprises a generally circular panel indicated by outer periphery C. Alternate panel shapes, such as diamond, polygonal, oval, or the like are also within the scope of the invention. The lens 40 is preferably fabricated from at least partially transparent, translucent or otherwise light-transmissive acrylic sheet material, or alternatively can comprise other types of plastics, glass, or other materials. One or more clip connection cutouts 42 are optionally provided, preferably in two, three, four or more evenly spaced locations along the sides of the lens 40. Alternatively the lens does not include any cutouts, and is frictionally or otherwise engaged along its edges or elsewhere by one or more clips or other attachment means.

The lens 40 defines at least one display surface 44 for receiving any of a variety of displays 46, as seen in FIG. 1. For example, graphical, textual, and/or other formats of designs can be applied to the displays surface for decorative purposes, to deliver information (e.g., an “exit” sign display), advertising, aesthetic, or other purposes. The display 46 can be applied by affixing a printed vinyl skin or decal onto the lens, by screen-printing, silk-screening, digital printing, painting, dyeing, frosting, and/or various other means. The display 46 can also be applied by screen printing or digitally printing an image on a clear, white, or any other color label (decal) or stock film and applying the film to the lens. Alternatively, the display is directly printed onto the lens. The display can be applied to the inner face of the lens (toward the light bulb), to the outer face of the lens (toward the interior of the room the fixture is mounted in), and/or within the body of the lens if applicable. The display is preferably at least partially translucent and/or comprises one or more colors contrasting with the base color of the display surface 44. Optionally, the display includes one or more reflective or refractive portions, phosphorescent portions, holographic portions, moving portions, color-changing portions, and/or other display elements. Optionally, the display can take the form of a popular cartoon character, a team logo, product merchandising text and/or graphics, branding materials, informational text or diagrams, patterns, artwork, and/or the like. In this manner, the lens defines a customizable luminous surface.

The lens 40 is preferably connected to the base 20 by one or more mounting brackets 60, shown in example form in FIG. 9. The bracket 60 includes a first clip 62 for permanent or semi-permanent attachment to the base 20, a second clip 64 for releasable attachment to the lens 40, and a curved or angled arm 66 extending between the first and second clips. The bracket 60 can be manufactured from materials such as, but not limited to, stainless steel, iron, copper, polycarbonate, plastic, etc. The manufacturing processes by which the bracket 60 can be made includes, but is not limited to, die casting or injection molding, depending on the material used and other factors, such as aesthetic appearance or desired surface finish. The arm of the mounting bracket preferably provides a degree of flexure to allow installation and removal of the lens as described herein. One or more openings 68 can optionally be provided adjacent the first clip 64 for receiving a screw, rivet, or other coupling member to further secure the bracket 60 to the base 20, as can be seen in more detail in FIGS. 4-5. The second clip is preferably configured to engage a clip connection cutout 42 formed along the periphery of the lens. Alternatively, if cutouts are not provided in the lens, the second clip can frictionally or otherwise engage the edge of the lens or other attachment portions of the lens. Preferably, the brackets securely but releasably engage the lens 40, to enable removal for lamp replacement or other service, for mounting access, and/or for interchanging different lenses for use with a universal base. The length of the arm 66 is preferably selected to provide a small gap between the base 20 and the lens 40, as shown best in FIG. 4, so that the display surface 44 of the lens is backlit by a portion of the light from the light source 22 in the base, and so that a portion of the light escapes between the base and the lens for direct or indirect lighting of the surrounding area; and to allow air circulation for heat dissipation.

In use, the user installs the fixture 10, for example by mounting it to a wall, ceiling or other surface, as by one or more screws, nails, hangers or other mounting means. Preferably the mounting means allows the fixture to be removed and remounted in a different location or different configuration without damaging the fixture or the surface to which it is mounted. The cord or other power connection is connected, and the light source switched on. Light illuminates the display from the back of the lens to provide a lighted display, for example having an appearance similar to a neon light in certain embodiments. Optionally, two or more alternate lens designs are provided and are interchangeably affixed to the mounting clips to produce different displays using a common or universal base and lighting components. In example forms, the base portion of the fixture may be provided separately from the lenses, and two or more alternate lens designs are available for the user to select from. The user may switch out alternate lens designs by releasing the lens from the clips without the need for tools or special instruction, allowing ease of customization and changing of the displayed subject matter. For example, a business may switch out lenses displaying “open” and “closed” to indicate their state of operation; a sports venue can switch out lenses depending on which teams are playing that day; a designer can switch out lenses of different colors to match a decorative theme; and/or other applications as desired by the user. The invention thus includes methods of display, methods of information delivery, and methods of advertising, by way of selective provision and application of the display utilized in connection with the above described fixture.

While the invention has been described with reference to preferred and example embodiments, it will be understood by those skilled in the art that a variety of modifications, additions and deletions are within the scope of the invention, as defined by the following claims.

What is claimed is:

1. A lighted display apparatus comprising:
a base having a back panel, a peripheral collar extending from the back panel, and a front that is at least partially open, the back panel comprising one or more mounting features for attachment to a support;
at least one light source mounted within the base for projecting light toward the at least partially open front of the base;
a plurality of mounting brackets, each mounting bracket having a first attachment portion, a second attachment portion, and a flexible arm between the first and second attachment portions; and
a lens comprising a substantially planar panel having a display applied thereon, at least a portion of which is light-transmissive, the lens being detachably affixed to the base by the plurality of mounting brackets, the first attachment portion of each mounting bracket being attached to the base and the second attachment portion of each mounting bracket being releasably attached to the lens, whereby flexure of the flexible arm portion of the mounting brackets allows attachment and removal of the lens.

2. The lighted display apparatus of claim 1, further comprising a reflector within the base for reflecting light from the at least one light source toward the at least partially open front of the base.

3. The lighted display apparatus of claim 1, wherein the plurality of mounting brackets hold the lens spaced a distance away from the at least partially open front of the base.

4. The lighted display apparatus of claim 1, wherein a plurality of lenses are provided, each having a different display applied thereon, whereby lenses can be interchangeably attached to the base.

5. The lighted display apparatus of claim 1, wherein the display comprises a logo.

6. The lighted display apparatus of claim 1, wherein the display comprises informational text.

7. The lighted display apparatus of claim 1, wherein the lens comprises a rectangular panel having four side edges.

8. The lighted display apparatus of claim 7, wherein each of the four side edges comprises a clip connection cutout for engagement with the second attachment portion of a mounting bracket.

9. The lighted display apparatus of claim 1, wherein the at least one light source comprises a fluorescent lamp.

10. A light fixture comprising a base having at least one light source positioned therein, a lens removably mounted over the at least one light source, and a display applied onto the lens for illumination by the light source.

11. The light fixture of claim 10, wherein at least two lenses are provided for interchangeable attachment to the base.

12. The light fixture of claim 10, wherein the lens is mounted to the base by way of at least one mounting bracket.

13. The light fixture of claim 10, wherein the display is selected from a cartoon character, a team logo, product merchandising text and/or graphics, branding materials, informational text or diagrams, patterns, artwork.

14. The light fixture of claim 10, wherein the lens has a translucent display surface with a background color and wherein the display comprises at least one color contrasting with the background color.

15. A display method comprising:
attaching a base to a support, the base having at least one light source mounted therein, and having a plurality of mounting brackets attached thereto; and
releasably attaching a first lens to the base, the lens comprising a panel having a first display applied thereon, at least a portion of which is light-transmissive.

16. The display method of claim 15, further comprising removing the first lens from attachment with the base, and installing a second lens having a second display applied thereon, the second display being different from the first display.

17. The display method of claim 15, wherein the first lens is spaced a distance from the base.

18. The display method of claim 15, further comprising actuating the at least one light source between a lighted and unlighted state.
